(19) United States
(12) Patent Application Publication
(10) Pub. No.: US 2008/0230615 A1
(43) Pub. Date: Sep. 25, 2008

(54) Near-field communication card for communication of contact information

(75) Inventors: Chris Read, San Diego, CA (US); Robert Hardacker, Escondido, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS, INC., Park Ridge, NJ (US)

(21) Appl. No.: 11/725,915

(22) Filed: Mar. 19, 2007

(51) Int. Cl. G06K 19/06

(52) U.S. Cl. 235/492

(57) ABSTRACT

User contact information may be stored in a memory of a near-field communication integrated circuit (IC) card. Upon detecting electromagnetic energy emitted by a reader/writer device, the IC card may power on and automatically transmit the stored contact information. In one embodiment, this transmission may be preceded by an authentication operation, and the contact information may be digitally signed so that the accuracy of the contact information may be verified by its recipient. In another embodiment, the contact information may be stored in one or more of a plurality of memory sections of the IC card. Upon the IC card being activated, the contact information may be transmitted from one such memory section based on a user memory section selection.

### FIELD OF THE INVENTION

The present invention relates generally to the field of radio frequency communications, and in particular to a near-field communication card for selectively communicating personal information.

### BACKGROUND OF THE INVENTION

The time-honored exchange of contact information using paper business cards has several significant drawbacks, the least of which is that the amount of contact information being exchanged has grown considerably and may no longer fit on a single business card. For example, contact information may include company names, department names, company addresses, company telephone numbers, cellular telephone numbers, facsimile numbers, email addresses, websites and so on.

Aside from the amount of the information to exchange, a change in any one of the individual pieces of contact information would require that the entire business card be replaced. This is obviously an inefficient and outdated approach to exchanging contact information.

While the amount of contact information being exchanged has been increasing, so too has the use of radio frequency identification (RFID) systems. Applications of RFID tags include replacement of bar codes in inventory management of consumer items, tracking of books in libraries or bookstores, shipping container and truck/trailer tracking and livestock tracking. In the automotive field, RFIDs are used in car keys to activate vehicles and for tire tracking.

A more recent incarnation of RFID systems are so-called near field communication (NFC) systems, which involve the use of short range wireless communication technology. However, unlike traditional RFID technology, NFC cards may be both read from, as well as written to, by an authorized reader/writer. The transmission frequency is centered at 13.56 Mhz and is used to transmit data at rates of up to 424 Kbps and is characterized by very low power consumption. Communication between two NFC-compatible devices occurs when such devices are positions within a close proximity to each other (e.g., four centimetres).

Because the transmission range is so short, NFC-enabled transactions are perceived to be inherently secure. Also, NFC systems typically employ an authentication step prior to allowing data transfer. Common NFC technology products include FeliCa™ (Sony) and MIFARE™ (Philips). The systems are based on a reader-writer/card architecture, in which a reader-writer initiates communication with a proximately-located NFC card. However, heretofore NFC technology has not been successfully implemented for the exchange of contact information in a manner which enables the selective communication of such information. As such, what is needed is a NFC card for communicating selective contact information.

### SUMMARY OF THE INVENTION

Disclosed and claimed herein is a near-field communication integrated circuit card and method of communicating therewith. In one embodiment, the card includes memory sections each containing corresponding user contact information, and an antenna circuit for receiving an electromagnetic energy from a reader/writer device. The card further includes a controller coupled to the antenna and the memory and configured to power on in response to the electromagnetic energy, detect a user selection of one of the memory sections, and transmit user contact information contained in the memory section that corresponds to the user selection.

In one embodiment of a method for communicating with a near field communication integrated circuit card, the method includes storing user contact information, receiving an electromagnetic energy signal emitted from a reader/writer device, and powering on in response to the electromagnetic energy signal. The method further includes transmitting, automatically, the user contact information to the reader/writer device as a near-field communication.

Other aspects, features, and techniques of the invention will be apparent to one skilled in the relevant art in view of the following description of the exemplary embodiments of the invention.

### BRIEF DESCRIPTION OF THE DRAWINGS

FIGS. 1A-1B illustrate a NFC system in accordance with one embodiment of the invention;

FIG. 2 is a process for carrying out one embodiment of the invention;

FIG. 3 illustrates an NFC IC card configured in accordance with another embodiment of the invention; and

FIG. 4 depicts a process for carrying out another embodiment of the invention.

### DETAILED DESCRIPTION OF THE EXEMPLARY EMBODIMENTS

Disclosed and claimed herein is a near-field communication integrated circuit card, and method for communicating therewith. As will be described herein, user contact information may be stored in a memory of the NFC IC card. Upon detecting electromagnetic energy emitted by an NFC reader/writer device, the IC card may power on and automatically transmit the stored contact information. This transmission may be preceded by an authentication operation. Similarly, the contact information may be digitally signed so that the accuracy of the contact information may be verified by its recipient.

In another embodiment, the contact information may be stored in one or more of a plurality of memory sections of the NFC IC. Upon the IC card being activated, the contact information may be transmitted from one such memory section based on a user memory section selection. Numerous other embodiments, aspects and features are disclosed herein.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

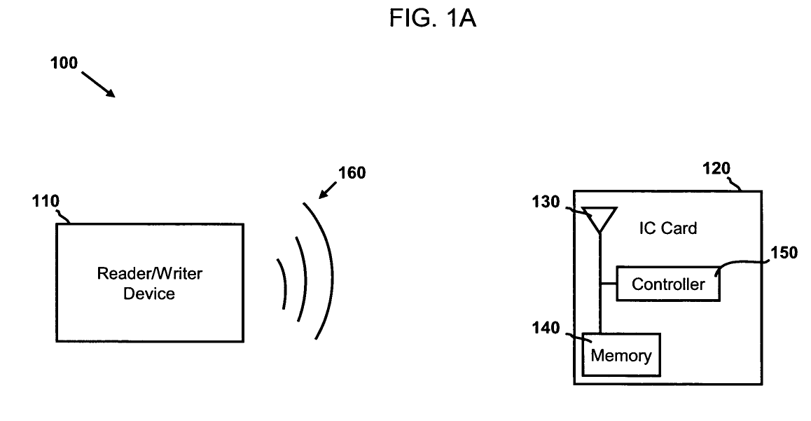

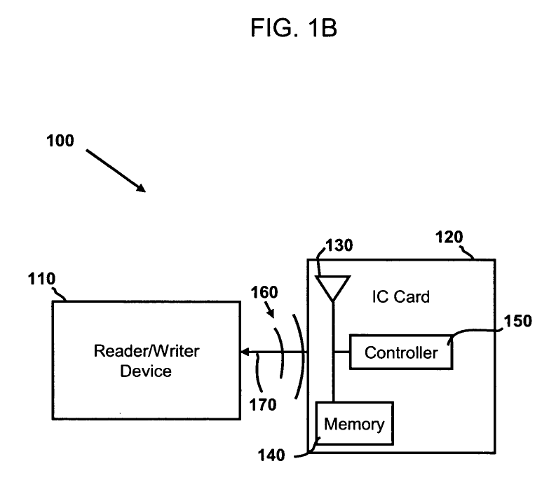

Referring now to the figures, FIG. 1A depicted is one embodiment of an NFC system 100 configured in accordance with the principles of the invention. In particular, the NFC system 100 includes a reader/writer device 110 and an integrated circuit (IC) card 120. As shown, the IC card 120 includes an antenna circuit 130, a memory 140 and a controller 150. In one embodiment, the IC card 100 may be a contactless IC card marketed by Sony Corporation under the trademark FeliCa™. However, it should equally be appreciated that other contactless IC cards may similarly be used in accordance with the principles of the invention. While in some embodiments, antenna circuit 130 may comprise a standard RFID antenna, in other embodiments it may be a transceiver circuit for both receiving and sending wireless data. Moreover, while the following described the IC card 120 as a passive device, in other embodiments it may be active NFC device having its own power source.

Controller 150 may be any microcontroller or similar processor, and in one embodiment is a reduced instruction set computer (RISC), such as an 8-, 16- or 32-bit RISC CPU. Memory 140 is configured to store user contact information, such a company name, department name, company address, company telephone number, cellular telephone number, facsimile number, email address, website, etc. It should be appreciated that such contact information may be transferred to the IC card 120 using either a wired interface (not shown) or via antenna circuit 130. While in one embodiment memory 140 may be Electronically Erasable Programmable Read-Only Memory (EEPROM), it should equally be appreciated that other types of non-volatile electronic memory may be similarly used (e.g., flash memory, non-volatile random access memory (NVRAM), etc).

Continuing to refer to FIG. 1A, reader/writer device 110 may be a NFC reader/writer device which emits electromagnetic energy 160 capable of powering up or activating the IC card 120. These so-called “cardwarming signals” may be employed to wake up the NFC devices which do not have built-in power supplies. In the embodiment of FIG. 1A, the IC card 120 is outside the range of the electromagnetic energy 160, and thus is not being activated by the reader/writer device 110. In one embodiment, IC card 120 may be constructed of a polyethylene terephthalate plastic having a size conforming to the ISO/IEC 7810ID-1 standard.

Referring now to FIG. 1B, depicted is the NFC system of FIG. 1A after the IC card 120 has come within range of the electromagnetic energy 160 of the reader/writer device 110. Once the IC card has been powered up by the electromagnetic energy 160, it may automatically transmit the user contact information stored in memory 140 in the form of NFC signal 170. It should be appreciated that an authentication or validation process may precede the transmission of the contact information. In certain embodiments, it may similarly be desirable to digitally sign the contact information by, for example, the user's employer, so as to authenticate the information being provided.

In one embodiment, NFC signal 170 has a frequency of 13.56 Mhz and transmits data at 212 kbps, other frequencies and data transmission rates are similarly consistent with the invention. In addition, NFC signal 170 being a near-field communication will have a limited effective distance. To that end, the communication distance for NFC signal 170 may be in the range of between approximately 2 cm and 10 cm. In certain embodiments, NFC signal 170 may conform to the ISO/IEC 18092 standard.

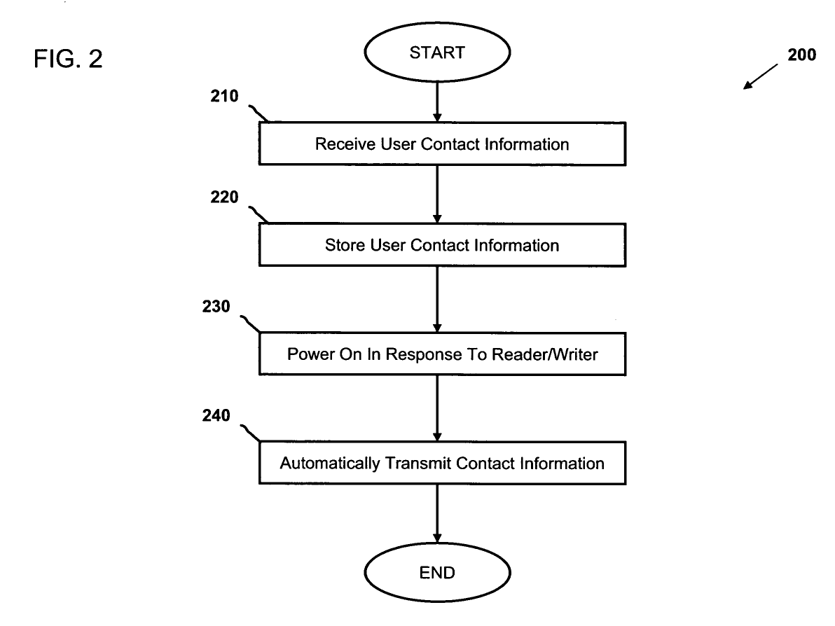

Referring now to FIG. 2, depicted is a process 200 for implementing one embodiment of the invention. In particular, process 200 begins when an NFC IC card (e.g., IC card 120 of FIGS. 1A-1B) receives user contact information. While in one embodiment, the user contact information may be received using a wired interface to a corresponding read/writer (e.g., reader/writer device 110), in another embodiment the NFC IC card includes a receiver or transceiver circuit (antenna circuit 130) for wirelessly receiving such contact information. Once the requisite contact information has been received, process 200 may continue to block 220 where the information is stored in a non-volatile memory (e.g., memory 140) of the NFC IC. It should be appreciated that such a storing operation may require a user password and/or key, as is generally known in the art.

Continuing to refer to FIG. 2, process 200 continues to block 230 where the NFC IC card may be powered on in response to receiving the electromagnetic energy emitted by an NFC reader/writer device that is configured to radiate electromagnetic waves capable of activating NFC IC cards. Once activated, the NFC IC card automatically accesses from memory and transmits the stored contact information at block 240. It should further be appreciated that the NFC IC card and associated reader/write device may perform an authentication operation prior to transmission of the contact information. Similarly, the contact information may be digitally signed so that the accuracy of the contact information may be verified against for example, the IC card user's employer.

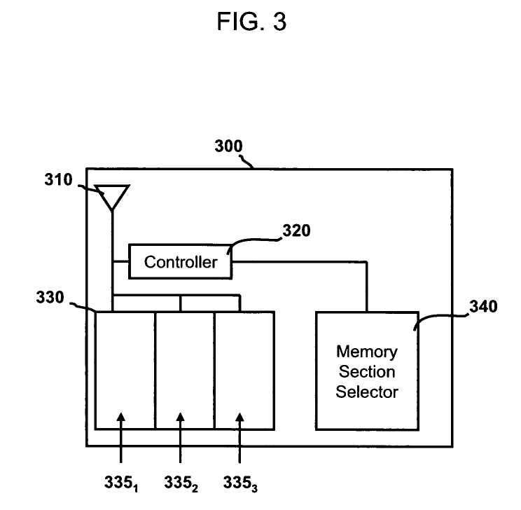

Referring now to FIG. 3, depicted is a near-field communication IC card 300 configured in accordance with one embodiment of the invention. As with the embodiment of FIG. 2, IC card 300, includes an antenna circuit 310 and a controller 320, where the antenna circuit 310 may comprise a standard RFID antenna, or may be a transceiver circuit for both receiving and sending wireless data. Similarly, controller 320 may be any microcontroller or similar processor, such as an 8-, 16- or 32-bit RISC CPU.

However, unlike the embodiment of FIG. 2, NFC IC card 300 includes a divided or segmented memory 330. In particular, memory 330 comprises a plurality of sections 335₁-335₃. Although depicted as having three sections, it should equally be appreciated that memory 330 may have more or fewer memory sections. It should further be appreciated that each of the plurality of sections 335₁-335₃ may be configured to store user contact information, such a company name, department name, company address, company telephone number, cellular telephone number, facsimile number, email address, website, etc. Such contact information may be transferred to the IC card 300 using either a wired interface (not shown) or via antenna circuit 310.

While in one embodiment memory 330 may be Electronically Erasable Programmable Read-Only Memory (EEPROM), it should equally be appreciated that other types of non-volatile electronic memory may be similarly used (e.g., flash memory, non-volatile random access memory (NVRAM), etc). Moreover, memory 330 may be a segmented memory wherein the plurality of sections 335₁-335₃ are physically divided and managed by a memory management unit (MMU) located either in memory 330 or in the controller 320. While in one embodiment, the plurality of sections 335₁-335₃ may be contiguously segmented, in another embodiment the MMU may be responsible for translating virtual addresses into physical addresses of the plurality of sections 335₁-335₃. Alternatively, memory 330 may be divided into the plurality of sections 335₁-335₃ using software, as is generally known.

Continuing to refer to FIG. 3, NFC IC 300 is further depicted as including memory section selector 340. In one embodiment, the memory section selector 340 is integrated with the IC card 300 and may comprise a biometric sensor, an electromechanical enable switch, or an electromechanical selector switch. To that end, and in one embodiment, a biometric sensor, such as a fingerprint reader embedded in the NFC IC 300 may allow access only when the appropriate finger is detected by the sensor. In another embodiment, a multi-position switch setting is input and stored only when matching finger is present. Similarly, the NFC IC 300 may be configured to only allow writing with a matching finger is present. In any event, it should be appreciated that the selection input means may interface with software executing on the controller 320 to “switch” to a selected section of the plurality of sections 335₁-335₃ by, for example, setting a value in a register or via a system call. Alternatively, or complimentary thereto, the selection input means may interface with the MMU (either in memory 330 or controller 320) to “switch” to a selected section of the plurality of sections 335₁-335₃.

The aforementioned configuration may be used to make certain section of memory 330 more public, while others more private. Moreover, each of the plurality of sections 335₁-335₃ may be read/write protected using any type of key/password access restriction. By way of example, some sections of memory 330 may be publicly read-only where such section include information which is to be shared (e.g. user contact information). By selecting or “switching” to such a memory section, the information may be freely transmitted when the IC card is properly activated. In this fashion, a user may provide select access to their information. For example, different memory sections may contain different levels of contact information so that on could allow one level of information (e.g. name, address, phone) with one section selection, but include another level (e.g., cell phone, home phone, email address) with another selection.

In addition thereto, some of the plurality of sections 335₁-335₃ may be configured as publicly write-only, such as for receiving contact information from others. Since such sections are write-only, those who add their own information will not have access to previously stored/collected. Again, such section may be readable/accessible with a valid key/password or with a valid biometric entry (e.g., fingerprint). In other embodiment, publicly write-only memory sections may include a sequence of data sets (e.g. business cards) which are stored cumulatively and not necessarily overwritten.

In another embodiment, the memory section selector 340 may be configured such that it, in combination with the control 320, may disable the antenna circuit 310 or otherwise cause it to be inoperative for receiving electromagnetic energy in response to an invalid biometric reading or electromechanical enable/selector switch setting. In this fashion, proximity-located NFC reader/writer device will not be able to even detect the presence of the NFC IC 300, thereby ensuring that inadvertent transmission do not occur.

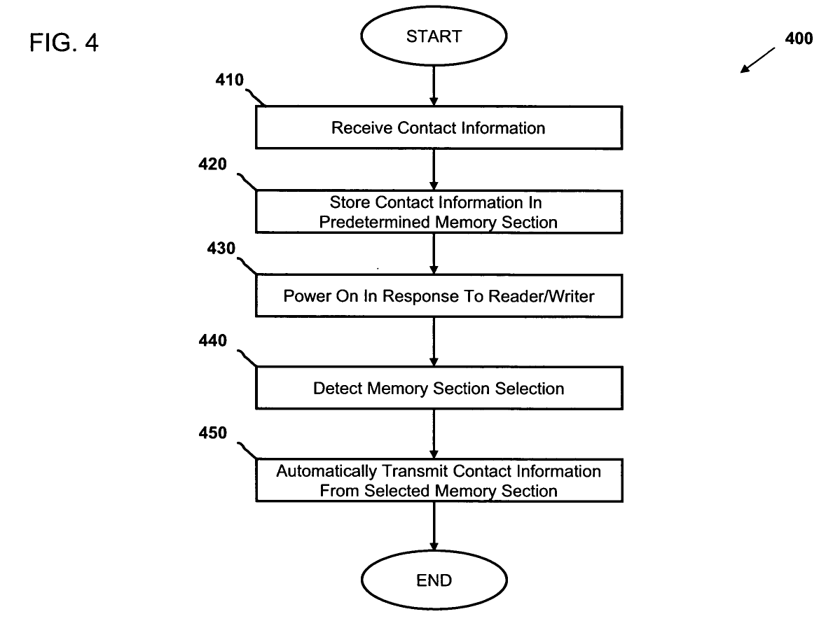

Referring now to FIG. 4, depicted is a process 400 for implementing another embodiment of the invention. In particular, process 400 begins when an NFC IC card (e.g., IC card 300 of FIG. 3) receives user contact information. While in one embodiment, the user contact information may be received using a wired interface to a corresponding read/writer (e.g., reader/writer device 110), it another embodiment the NFC IC card includes a receiver or transceiver circuit (antenna circuit 310) for wirelessly receiving such contact information. Once the requisite contact information has been received, process 400 may continue to block 420 where the information is stored in a non-volatile memory (e.g., memory 330) of the NFC IC. It should be appreciated that such a storing operation may require a user password and/or key, as is generally known in the art. In addition, it should be appreciated that the contact information received at block 410 may be stored in a predetermined section of the memory (e.g., plurality of sections 335₁-335₃).

Continuing to refer to FIG. 4, process 400 continues to block 430 where the NFC IC card may be powered on in response to receiving the electromagnetic energy emitted by an NFC reader/writer device. Once activated, the NFC IC card automatically accesses from memory and transmits the stored contact information at block 240. It should further be appreciated that the NFC IC card and associated reader/write device may perform an authentication operation prior to transmission of the contact information. Similarly, the contact information may be digitally signed so that the accuracy of the contact information may be verified against for example, the IC card user's employer.

Process 400 may then continue to block 440 where a memory section selection may be detected. In one embodiment, the memory section selection to be detected may correspond to a selection made using an integrated memory section selector, such as the memory section selector 340 of FIG. 3. Moreover, it should be appreciated that the detection operation of block memory section selection of block 440 may be performed by a controller (e.g., controller 320) of the IC card based on information received from an MMU of the memory or software equivalent. Such information may be in the form of a register value, system call, flag or similar indicator means.

Process 400 concludes at block 450 with the automatic transmission of the contact information from the memory section detected at block 440. As described above with reference to FIG. 3, the selected memory section may correspond to a user selection that is received before the power on operation of block 430. Moreover, certain memory sections may be designated as publicly read-only or publicly write-only, as detailed above with reference to FIG. 3.

While the preceding description has been directed to particular embodiments, it is understood that those skilled in the art may conceive modifications and/or variations to the specific embodiments described herein. Any such modifications or variations which fall within the purview of this description are intended to be included herein as well. It is understood that the description herein is intended to be illustrative only and is not intended to limit the scope of the invention.

What is claimed is:

1. A near-field communication integrated circuit card comprising:
a memory including a plurality of memory sections each containing corresponding user contact information;
an antenna circuit for receiving an electromagnetic energy from a reader/writer device; and
a controller coupled to said antenna and said memory, the controller configured to,
power on in response to the electromagnetic energy,
detect a user selection of one of said plurality of memory sections, and
transmit user contact information contained in one of said plurality of memory sections corresponding to said user selection.

2. The near-field communication integrated circuit card of claim 1, wherein said processor is further configured to receive said user selection prior to powering on in response to the electromagnetic energy.

3. The near-field communication integrated circuit card of claim 1, wherein said antenna circuit further comprises a transceiver circuit for both receiving and transmitting said user contact information.

4. The near-field communication integrated circuit card of claim 1, wherein said memory, antenna circuit and controller are affixed to a polyethylene terephthalate plastic substrate.

5. The near-field communication integrated circuit card of claim 1, wherein said near-field communication integrated circuit card further includes an input means for receiving said user selection.

6. The near-field communication integrated circuit card of claim 1, wherein said input means comprises one of a biometric sensor, an electromechanical selector switch and an electromechanical enable switch.

7. The near-field communication integrated circuit card of claim 1, wherein one of said plurality of memory sections is designated as publicly read-only.

8. The near-field communication integrated circuit card of claim 1, wherein one of said plurality of memory sections is designated as publicly write-only.

9. The near-field communication integrated circuit card of claim 1, wherein the controller is further configured to not transmit said user contact information unless said user selection is detected.

10. The near-field communication integrated card of claim 1, wherein the user contact information is digitally signed by a third-party authentication authority.

11. A near-field communication integrated circuit card comprising:
a memory configured to store user contact information;
an transceiver circuit configured to receive and transmit said user contact information;
a controller coupled to said transceiver circuit and said memory, the controller configured to,
power on in response to electromagnetic energy emitted from a reader/writer device;
transmit, automatically, said user contact information as a near-field communication.

12. The near-field communication integrated circuit card of claim 11, wherein said memory includes a plurality of memory sections at least one of which is to store said user contact information.

13. The near-field communication integrated circuit card of claim 12, wherein the controller is further configured to detect a user selection of one of said plurality of memory sections.

14. The near-field communication integrated circuit card of claim 13, wherein said processor is further configured to receive said user selection prior to powering on in response to the electromagnetic energy.

15. The near-field communication integrated circuit card of claim 13, wherein said near-field communication integrated circuit card further includes an input means for receiving said user selection.

16. The near-field communication integrated circuit card of claim 15, wherein said input means comprises one of a biometric sensor, an electromechanical selector switch and an electromechanical enable switch.

17. The near-field communication integrated circuit card of claim 12, wherein one of said plurality of memory sections is designated as publicly read-only.

18. The near-field communication integrated circuit card of claim 12, wherein one of said plurality of memory sections is designated as publicly write-only.

19. The near-field communication integrated circuit card of claim 11, wherein said memory, antenna circuit and controller are affixed to a polyethylene terephthalate plastic substrate.

20. The near-field communication integrated circuit card of claim 11, wherein the controller is further configured to not transmit said user contact information unless said user selection is detected.

21. The near-field communication integrated card of claim 11, wherein the user contact information is digitally signed by a third-party authentication authority.

22. A method for communicating with a near field communication integrated circuit card comprising:
storing user contact information;
receiving an electromagnetic energy signal emitted from a reader/writer device;
powering on in response to said electromagnetic energy signal
transmitting, automatically, said user contact information to said reader/writer device as a near-field communication.

23. The method of claim 22, wherein storing comprises storing said user contact information in at least one of a plurality of memory sections of said integrated circuit card.

24. The method of claim 23, further comprising detecting a user selection of one of said plurality of memory sections.

25. The method of claim 24, further comprising receiving the user selection prior to said powering on.

26. The method of claim 25, wherein receiving the user selection comprises receiving the user selection of as one of a biometric sensor signal, an electromechanical selector switch and an electromechanical enable switch.

27. The method of claim 23, further comprising designating one of said plurality of memory sections as publicly read-only.

28. The method of claim 23, further comprising designating one of said plurality of memory sections as publicly write-only.
